(19) United States
(12) Patent Application Publication
(10) Pub. No.: US 2026/0197721 A1
(43) Pub. Date: Jul. 9, 2026

(54) NETWORK SHARING TECHNIQUES FOR MULTI-OPERATOR CORE NETWORKS

(71) Applicant: QUALCOMM Incorporated, San Diego, CA (US)

(72) Inventors: Jun DENG, Shanghai (CN); Sagar LNU, Hyderabad (IN); Uttam VYAS, Hyderabad (IN); Avinash Kumar DUBEY, Hyderabad (IN)

(21) Appl. No.: 19/128,482

(22) PCT Filed: Feb. 1, 2023
(86) PCT No.: PCT/CN2023/074074

§ 371 Date: May 8, 2025

(51) Int. Cl. H04W 36/00; H04W 84/04

(52) U.S. Cl. CPC H04W 36/0055; H04W 84/042

(57) ABSTRACT

Methods, systems, and devices for wireless communications are described. A user equipment (UE) may receive a message that includes a multi-operator core network (MOCN) frequency indicator that indicates whether an operating frequency is configured with at least one shared cell that is associated with multiple public land mobile network (PLMN) identities. The UE may perform a cell selection or reselection procedure to select a cell associated with the operating frequency based on the cell satisfying a threshold such as a quality threshold. The UE may then select, as part of the cell reselection procedure, a shared cell associated with the operating frequency based on the cell being unavailable for selection based on a PLMN identity associated with the cell, and the MOCN frequency indicator indicating that the operating frequency is configured with the at least one shared cell.

### CROSS REFERENCE

The present Application is a 371 national phase filing of International PCT Application No. PCT/CN2023/074074 by DENG et al., entitled “NETWORK SHARING TECHNIQUES FOR MULTI-OPERATOR CORE NETWORKS,” filed Feb. 1, 2023, which is assigned to the assignee hereof, and which is expressly incorporated by reference in its entirety herein.

### FIELD OF TECHNOLOGY

The following relates to wireless communications, including network sharing techniques for multi-operator core networks (MOCN).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support multi-operator core network (MOCN) functionality, which may enable access to a single radio access network (RAN) by multiple operators.

### SUMMARY

The described techniques relate to improved methods, systems, devices, and apparatuses that support network sharing techniques for multi-operator core networks (MOCN). For example, the described techniques support efficient cell reselection for a user equipment (UE) operating in a MOCN. The UE may receive signaling from the network that configures both shared (e.g., MOCN) cells and unshared cells to operate within the same frequency via a MOCN frequency indicator information element and a MOCN PLMN identity list information element. The MOCN frequency indicator and the MOCN PLMN identity list may indicate whether MOCN frequency sharing is configured for some or all of the cells, and which PLMNs correspond to the shared frequency, respectively. The UE may perform a cell selection or reselection procedure to select a cell associated with the operating frequency. For example, the UE may select a shared (e.g., MOCN) cell associated with the operating frequency even if the cell is determined to be unavailable for selection (e.g., based on a PLMN identity associated with the cell being different from a PLMN identity registered to the UE). In such examples, the MOCN frequency indicator may indicate that the operating frequency is configured with at least one shared cell, such that the UE may not bar the operating frequency entirely. Instead, the UE may continue to search the MOCN PLMN identity list to identify a cell configured for the operating frequency with the same PLMN identity as the PLMN identity registered to the UE. For example, the UE may select another cell (e.g., the shared cell) associated with the same frequency when the UE refrains from barring the frequency when the cell is unavailable for selection.

A method for wireless communication at a UE is described. The method may include receiving a message including a MOCN frequency indicator that indicates whether a frequency is configured with at least one shared cell that is associated with multiple PLMN identities, performing a cell reselection procedure to select a cell associated with the frequency based on the cell satisfying a threshold, and selecting, as part of the cell reselection procedure, a shared cell associated with the frequency based on the cell being unavailable for selection and the MOCN frequency indicator indicating that the frequency is configured with the at least one shared cell, where the cell is unavailable based on a PLMN identity associated with the cell.

An apparatus for wireless communication at a UE is described. The apparatus may include a processor, memory coupled with the processor, and instructions stored in the memory. The instructions may be executable by the processor to cause the apparatus to receive a message including a MOCN frequency indicator that indicates whether a frequency is configured with at least one shared cell that is associated with multiple PLMN identities, perform a cell reselection procedure to select a cell associated with the frequency based on the cell satisfying a threshold, and select, as part of the cell reselection procedure, a shared cell associated with the frequency based on the cell being unavailable for selection and the MOCN frequency indicator indicating that the frequency is configured with the at least one shared cell, where the cell is unavailable based on a PLMN identity associated with the cell.

Another apparatus for wireless communication at a UE is described. The apparatus may include means for receiving a message including a MOCN frequency indicator that indicates whether a frequency is configured with at least one shared cell that is associated with multiple PLMN identities, means for performing a cell reselection procedure to select a cell associated with the frequency based on the cell satisfying a threshold, and means for selecting, as part of the cell reselection procedure, a shared cell associated with the frequency based on the cell being unavailable for selection and the MOCN frequency indicator indicating that the frequency is configured with the at least one shared cell, where the cell is unavailable based on a PLMN identity associated with the cell.

A non-transitory computer-readable medium storing code for wireless communication at a UE is described. The code may include instructions executable by a processor to receive a message including a MOCN frequency indicator that indicates whether a frequency is configured with at least one shared cell that is associated with multiple PLMN identities, perform a cell reselection procedure to select a cell associated with the frequency based on the cell satisfying a threshold, and select, as part of the cell reselection procedure, a shared cell associated with the frequency based on the cell being unavailable for selection and the MOCN frequency indicator indicating that the frequency is configured with the at least one shared cell, where the cell is unavailable based on a PLMN identity associated with the cell.

In some examples of the method, apparatuses, and non-transitory computer-readable medium described herein, receiving the message may include operations, features, means, or instructions for receiving the message including a MOCN PLMN identity list that includes one or more MOCN PLMN identities configured for the frequency, where selecting the shared cell may be based on the MOCN PLMN identity list.

Some examples of the method, apparatuses, and non-transitory computer-readable medium described herein may further include operations, features, means, or instructions for identifying a first PLMN identity from the MOCN PLMN identity list that may be equivalent to a PLMN identity registered to the UE, the first PLMN identity being one of the multiple PLMN identities associated with the shared cell and communicating with a network entity associated with the shared cell based on the shared cell being associated with the PLMN identity that may be equivalent to the PLMN identity registered to the UE.

In some examples of the method, apparatuses, and non-transitory computer-readable medium described herein, identifying, based on the MOCN PLMN identity list, one or more cells that may be each associated with PLMN identities not equivalent to a PLMN identity registered to the UE and barring the one or more cells for a time duration based on the PLMN identities being not equivalent to the PLMN identity registered to the UE.

In some examples of the method, apparatuses, and non-transitory computer-readable medium described herein, the MOCN PLMN identity list includes a PLMN identity information list indicating the one or more MOCN PLMN identities corresponding to respective cells configured for the frequency.

Some examples of the method, apparatuses, and non-transitory computer-readable medium described herein may further include operations, features, means, or instructions for refraining from barring the frequency in response to a determination that the cell associated with the frequency may be unavailable for selection, where the frequency may be excluded from barring based on the MOCN frequency indicator indicating that the frequency may be configured with the at least one shared cell.

Some examples of the method, apparatuses, and non-transitory computer-readable medium described herein may further include operations, features, means, or instructions for searching, as part of the cell reselection procedure, for the shared cell associated with the frequency based on the frequency being excluded from barring.

In some examples of the method, apparatuses, and non-transitory computer-readable medium described herein, receiving the message may include operations, features, means, or instructions for receiving the message including the MOCN frequency indicator via a broadcast message, a system information block (SIB), a unicast message, a radio resource control (RRC) message, or any combination thereof.

In some examples of the method, apparatuses, and non-transitory computer-readable medium described herein, the MOCN frequency indicator may be included in an intra-frequency carrier information element, or an inter-frequency carrier information element, or an inter-radio access technology (RAT) information element.

In some examples of the method, apparatuses, and non-transitory computer-readable medium described herein, the MOCN frequency indicator includes an information element including a Boolean indicator that indicates whether the frequency may be configured with the at least one shared cell.

A method for wireless communication at a network entity is described. The method may include transmitting a message including a MOCN frequency indicator that indicates whether a frequency is configured with at least one shared cell that is associated with multiple PLMN identities and communicating with a UE on a shared cell associated with the frequency based on the MOCN frequency indicator indicating that the frequency is configured with the at least one shared cell.

An apparatus for wireless communication at a network entity is described. The apparatus may include a processor, memory coupled with the processor, and instructions stored in the memory. The instructions may be executable by the processor to cause the apparatus to transmit a message including a MOCN frequency indicator that indicates whether a frequency is configured with at least one shared cell that is associated with multiple PLMN identities and communicate with a UE on a shared cell associated with the frequency based on the MOCN frequency indicator indicating that the frequency is configured with the at least one shared cell.

Another apparatus for wireless communication at a network entity is described. The apparatus may include means for transmitting a message including a MOCN frequency indicator that indicates whether a frequency is configured with at least one shared cell that is associated with multiple PLMN identities and means for communicating with a UE on a shared cell associated with the frequency based on the MOCN frequency indicator indicating that the frequency is configured with the at least one shared cell.

A non-transitory computer-readable medium storing code for wireless communication at a network entity is described. The code may include instructions executable by a processor to transmit a message including a MOCN frequency indicator that indicates whether a frequency is configured with at least one shared cell that is associated with multiple PLMN identities and communicate with a UE on a shared cell associated with the frequency based on the MOCN frequency indicator indicating that the frequency is configured with the at least one shared cell.

In some examples of the method, apparatuses, and non-transitory computer-readable medium described herein, transmitting the message may include operations, features, means, or instructions for transmitting the message including a MOCN PLMN identity list that includes one or more MOCN PLMN identities configured for the frequency, where communicating with the UE may be based on the MOCN PLMN identity list.

In some examples of the method, apparatuses, and non-transitory computer-readable medium described herein, communicating with the UE may include operations, features, means, or instructions for communicating with the UE on the shared cell based on the MOCN PLMN identity list including a PLMN identity that may be equivalent to a PLMN identify registered to the UE.

In some examples of the method, apparatuses, and non-transitory computer-readable medium described herein, the MOCN PLMN identity list includes a PLMN identity information list indicating the one or more MOCN PLMN identities corresponding to respective cells configured for the frequency.

In some examples of the method, apparatuses, and non-transitory computer-readable medium described herein, transmitting the message may include operations, features, means, or instructions for transmitting the message including the MOCN frequency indicator via a broadcast message, a SIB, a unicast message, an RRC message, or any combination thereof.

### BRIEF DESCRIPTION OF THE DRAWINGS

FIGS. 1 and 2 illustrate examples of wireless communications systems that support network sharing techniques for multi-operator core networks (MOCN) in accordance with one or more aspects of the present disclosure.

FIG. 3 illustrates an example of a process flow that supports network sharing techniques for MOCN in accordance with one or more aspects of the present disclosure.

FIGS. 4 and 5 illustrate block diagrams of devices that support network sharing techniques for MOCN in accordance with one or more aspects of the present disclosure.

FIG. 6 illustrates a block diagram of a communications manager that supports network sharing techniques for MOCN in accordance with one or more aspects of the present disclosure.

FIG. 7 illustrates a diagram of a system including a device that supports network sharing techniques for MOCN in accordance with one or more aspects of the present disclosure.

FIGS. 8 and 9 illustrate block diagrams of devices that support network sharing techniques for MOCN in accordance with one or more aspects of the present disclosure.

FIG. 10 illustrates a block diagram of a communications manager that supports network sharing techniques for MOCN in accordance with one or more aspects of the present disclosure.

FIG. 11 illustrates a diagram of a system including a device that supports network sharing techniques for MOCN in accordance with one or more aspects of the present disclosure.

FIGS. 12 and 13 illustrate flowcharts showing methods that support network sharing techniques for MOCN in accordance with one or more aspects of the present disclosure.

### DETAILED DESCRIPTION

In some wireless communications systems, a user equipment (UE) may perform cell selection or reselection on a cell or carrier that corresponds to a public land mobile network (PLMN) registered to the UE. Some such systems may also support multi-operator core network (MOCN) functionalities, which allows for radio access sharing between different network operators. In such cases, a same operating frequency (e.g., carrier frequency) may be associated with multiple cells having different cell identifiers, and at least one cell may be associated with multiple PLMN identities.

Due to various factors, such as mobility of the UE and overall communications quality, the UE may intermittently perform cell reselection to select a different cell that has a relatively improved quality or a higher rank than a previous cell on the same operating frequency. In some cases, however, this cell reselection procedure may fail because even though the new cell operates at the same operating frequency as the previous cell, it may be associated with a different PLMN identifier than the previous cell. In such cases, if the UE attempts to perform cell reselection with a same operating frequency and a different PLMN (such as in the case of MOCN), the UE may bar reselection on this cell and all other cells on this frequency for some time duration (e.g., five minutes). Such barring of an entire frequency is relatively inefficient for cell reselection procedures at the UE.

To support efficient cell reselection and overall increases in communications quality and reliability, the network may provide, to the UE, signaling that configures both shared (e.g., MOCN) cells and unshared cells to operate within the same frequency, thus allowing the UE to perform efficient cell reselection for all cells configured on the same frequency. For example, a network entity may transmit a MOCN frequency indicator information element (e.g., MOCNFrequencyIndicator) and a MOCN PLMN identity list information element (e.g., MOCNP1 mn-IdentityList) that indicate whether MOCN frequency sharing is configured for some or all of the cells, and which PLMNs correspond to the shared frequency. Specifically, the MOCN frequency indicator information element may indicate whether one or more cells of a frequency have MOCN frequency sharing configured, and the MOCN PLMN identity list may indicate a list of PLMNs for cells configured on the shared frequency.

Using the MOCN frequency indicator information element, the MOCN PLMN identity list information element, or both, the UE may determine whether MOCN frequency sharing is configured for a cell, and may not bar the frequency associated with that cell even if a PLMN of the cell does not match the PLMN registered to the UE (e.g., when attempting cell selection/reselection with a cell associated with that frequency). Additionally, the UE may search the PLMN identity list to determine whether one or more cells having a certain frequency have the same PLMN as registered to the UE.

Aspects of the disclosure are initially described in the context of wireless communications systems. Aspects of the disclosure are further illustrated by and described with reference to a process flow, apparatus diagrams, system diagrams, and flowcharts that relate to network sharing techniques for MOCN.

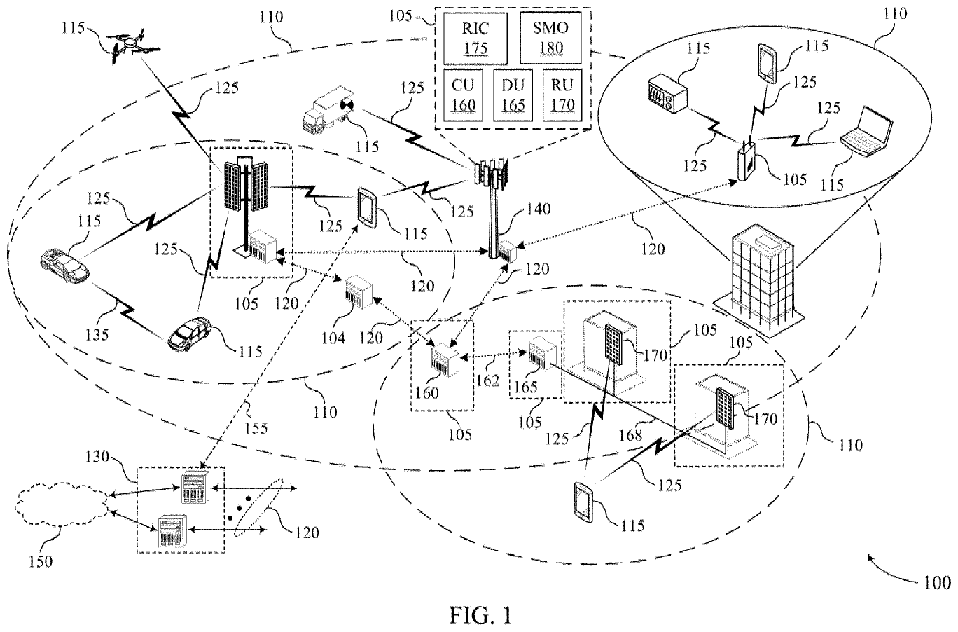

FIG. 1 illustrates an example of a wireless communications system 100 that supports network sharing techniques for MOCN in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support network sharing techniques for MOCN as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Wireless communications system 100 may support both shared cells and unshared cells on a same frequency. For example, systems may support radio access network (RAN) sharing between different operators, which may be referred to as a MOCN. In some cases, however, an unshared cell may be associated with relatively high power (e.g., satisfying a threshold), and a UE 115 may fail to camp on the cell (and may subsequently fail re-selection on this cell) based on the cell having a PLMN identity that is not equivalent to the PLMN identity associated with the UE 115. Such reselection failure may result in EARFCN barring for five minutes, where the UE 115 bars all cells on the frequency of the shared cell, so the UE will not consider any other cells on the same frequency for re-selection, even if these other cells have a same PLMN identity, such as in the case of shared (e.g., MOCN) cells.

In some examples, the network may configure both shared cell (cells which are associated with more than one PLMN) and unshared cells (cells which are associated with a single PLMN) on same frequency. A UE 115 (having a subscriber identity module (SIM)) may camp on a shared cell, and may multiple inter-frequency and inter-RAT neighbor cell information in system information (SIB) signaling. In some cases, however, a neighbor frequency list may have both shared cells and unshared cells, and the UE 115 may fail re-selection on a shared cell if the cell has a PLMN that is non-equivalent to the PLMN registered to the UE 115. Then, in cases of reselection failure, the UE may bar the EARFCN including the entire frequency associated with the shared cell for five minutes, such that the UE 115 may not consider other unshared or shared cells for reselection, which may reduce potential service quality.

To support efficient cell reselection and overall increases in communications quality and reliability, a network entity 105 may transmit, to the UE 115, signaling that configures both shared (e.g., MOCN) cells and unshared cells to operate within the same frequency, thus allowing the UE 115 to perform efficient cell reselection for all cells configured on the same frequency. For example, the network entity 105 may transmit a MOCN frequency indicator information element and a MOCN PLMN identity list information element that indicate whether MOCN frequency sharing is configured for some or all of the cells, and which PLMNs correspond to the shared frequency. Specifically, the MOCN frequency indicator information element may indicate whether one or more cells of a frequency have MOCN frequency sharing configured, and the MOCN PLMN identity list may indicate a list of PLMNs for cells configured on the shared frequency. The UE 115 may use the information elements to determine whether MOCN frequency sharing is configured for a cell, and may not bar the frequency associated with that cell even if the PLMN of the cell does not match the PLMN registered to the UE 115. Additionally, the UE may search the PLMN identity list to determine whether one or more cells having a certain frequency have the same PLMN as registered to the UE 115.

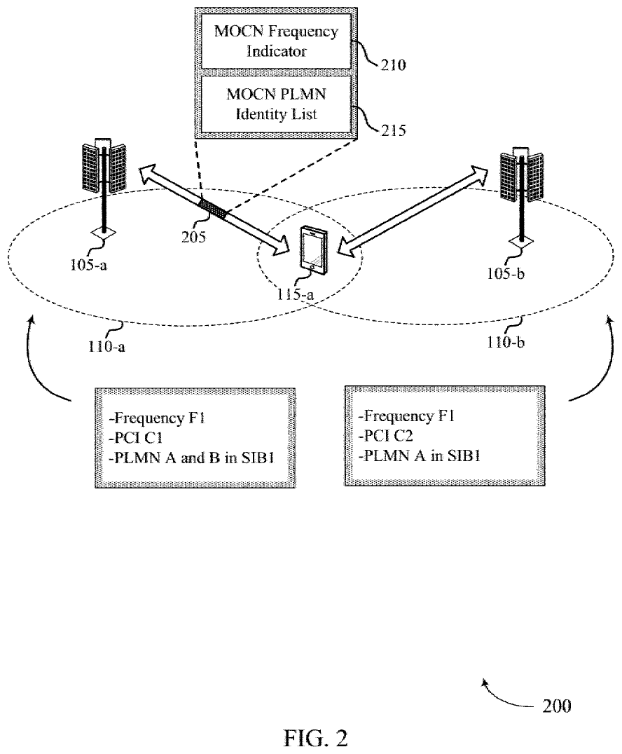

FIG. 2 illustrates an example of a wireless communications system 200 that supports network sharing techniques for MOCN in accordance with one or more aspects of the present disclosure. For example, wireless communications system 200 may support communications between a UE 115-a, a network entity 105-a, and a network entity 105-b, each of which may be examples of corresponding devices described with reference to FIG. 1.

In some wireless communications systems such as wireless communications system 200, the UE 115-a may synchronize with (e.g., camp on) a cell or carrier (e.g., cell 110-a, cell 110-b), that corresponds to a PLMN registered to the UE 115-a. For example, the UE 115-a may identify the cell that has a relatively highest rank from a set of cells having a same frequency and a PLMN that matches the PLMN registered to the UE 115-a. In addition, the wireless communications system 200 may support radio access network (RAN) sharing between different operators, which may be referred to as a MOCN. In such cases, a same frequency (e.g., carrier frequency) may be associated with multiple cells having different cell identifiers, and at least one cell may be associated with multiple PLMN identities. For example, MOCN functionality may allow a network operator to provide access to a single RAN by other operators, where each operator operates its own core network, including one or more independent network nodes.

Due to mobility of the UE 115-a, service quality, and other factors, the UE 115-a may intermittently perform cell re-selection to re-select a different cell on a same frequency that has a relatively improved signal quality or a higher rank than a previously selected cell, for example, according to absolute priority reselection rules. In some cases, however, the cell reselection procedure may fail because even though the new cell operates at the same frequency as the previously selected cell, it may have a different PLMN than the previously selected cell. For example, the network may be unable to configure frequency sharing for cells in a licensed spectrum that correspond to different PLMNs, and cell reselection may fail if the UE 115-a attempts to perform the cell reselection with an inter-frequency cell or an intra-frequency cell that has the same frequency as the previous cell, but a different PLMN (such as in the case of MOCN). Further, based on the failed reselection, the UE 115-a may bar (e.g., not consider) reselection on this cell (and all other cells) on this frequency for some time duration (e.g., up to 300 seconds or 5 minutes). Such barring or restriction of an entire frequency may lead to reduction in communications quality and reliability, and is relatively inefficient for cell reselection procedures.

To support enhanced cell selection and increased communications quality and reliability for MOCN configured systems, a network entity 105-a may transmit (e.g., broadcast) one or more information elements to configure both shared (e.g., MOCN) cells and unshared cells to operate within the same frequency, which may allow the UE 115-a to perform efficient cell reselection for all cells configured on the same frequency. For example, the network entity 105-a may transmit information elements including a MOCN frequency indicator information element 210 and a MOCN PLMN identity list information element 215 (e.g., MOCNFrequencyIndicator and MOCNP1 mn-IdentityList) via broadcast signaling 205 (system information block (SIB) carrying intra-frequency, inter-frequency, and inter-RAT neighbor cells and frequency information) or unicast signaling (radio resource control (RRC)) signaling such as RRC release with redirection and idle mode mobility. These information elements may indicate whether MOCN frequency sharing is configured for some or all of the cells, and which PLMNs correspond to the shared frequency. For example, the MOCN frequency indicator information element 210 may indicate whether one or more cells of a frequency have MOCN frequency sharing configured (e.g., using a Boolean indicator), and the MOCN PLMN identity list information element 215 indicates a list of shared PLMNs configured on the shared frequency (e.g., PLMN-Identity InfoList).

In some examples, the UE 115-a may determine whether MOCN frequency sharing is configured for a cell, and may not bar the frequency associated with that cell if the PLMN of the cell does not match the PLMN registered to the UE 115-a. Additionally, or alternatively, if the network configures MOCN frequency sharing, the network entity 105-a (or the network entity 105-b) may send the MOCN frequency indicator information element 210 having a Boolean indicator set as “TRUE,” and the UE 115-a may be able to search the MOCN PLMN identity list information element 215 to determine whether one or more cells having a certain frequency have the same PLMN as registered to the UE 115-a. In cases that at least one cell included in the MOCN PLMN identity list information element 215 has the same PLMN as the UE 115-a, the UE 115-a may continue cell search on the frequency. If no cells included in the MOCN PLMN identity list information element 215 have the same PLMN as the UE 115-a, the UE 115-a may bar the frequency for a configured time duration, for example, to avoid multiple attempts for reselection of cells in the MOCN PLMN identity list information element 215.

In some examples, the configuration of MOCN sharing via the information elements MOCNFrequencyIndicator and MOCNP1 mn-IdentityList may allow for enhanced cell-level sharing and efficient cell reselection. In the example of wireless communications system 200, the UE 115-a which receives the MOCN Frequency Indicator may perform cell reselection to attempt to connect to a highest-ranked cell (e.g., PCI C2) associated with a frequency F1 from a lower ranked cell. When the cell reselection fails due to the cell belonging to a PLMN (e.g., PLMN A) that is not equivalent to the registered PLMN of the UE 115-a (e.g., PLMN B), instead of barring the entire frequency F1, the UE 115-a instead selects a MOCN cell (e.g., PCI C1) associated with the same frequency F1 based on the MOCN Frequency Indicator. Additionally, or alternatively, in examples where MOCN frequency sharing is configured for the cells via the MOCN frequency indicator information element 210, the UE 115-a may continue a cell search on frequency F1, even after determining a non-equivalent PLMN.

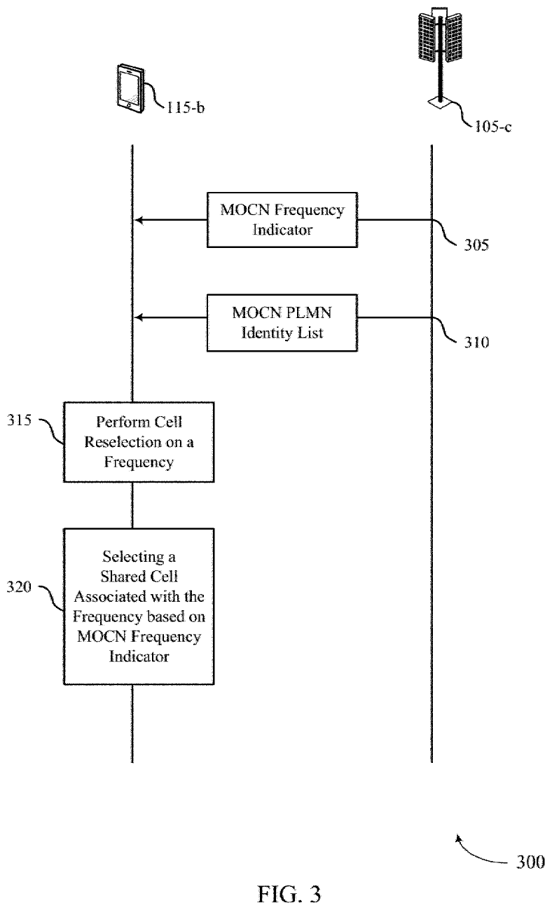

FIG. 3 illustrates an example of a process flow 300 that supports network sharing techniques for MOCN in accordance with one or more aspects of the present disclosure. The process flow 300 may implement or may be implemented to realize or facilitate aspects of the wireless communications system 100 and 200. For example, the process flow 300 illustrates communication between a UE 115-b, and a network entity 105-c. The UE 115-b and the network entity 105-c as illustrated by and described with reference to FIG. 3 may be examples of corresponding devices illustrated and described herein, including with reference to FIGS. 1 and 2. In some examples, the UE 115-b and the network entity 105-c may support MOCN communications.

In the following description of the process flow 300, the operations may be performed (such as reported or provided) in a different order than the order shown, or the operations performed by the example devices may be performed in different orders or at different times. Some operations also may be left out of the process flow 300, or other operations may be added to the process flow 300. Further, although some operations or signaling may be shown to occur at different times for discussion purposes, these operations may actually occur at the same time.

At 305, the UE 115-b may receive, from the network entity 105-c, a message that includes a MOCN frequency indicator that indicates whether a frequency is configured with at least one shared cell that is associated with multiple PLMN identities. For example, the MOCN frequency indicator may be an information element that includes a Boolean indicator that indicates whether the frequency is configured with the at least one shared cell.

At 310, the UE 115-b may receive a message (e.g., a same or different message from the message received at 305) that includes a MOCN PLMN identity list that includes one or more MOCN PLMN identities configured for the frequency. For example, the MOCN PLMN identity list may include a PLMN identity information list indicating the one or more MOCN PLMN identities corresponding to respective cells configured for the frequency. The UE 115-b may receive the MOCN frequency indicator and the MOCN PLMN identity list via a broadcast message, a SIB, a unicast message, an RRC message, or any combination thereof. In some examples, the MOCN frequency indicator, the MOCN PLMN identity information list, or both, are included in an intra-frequency carrier information element, or an inter-frequency carrier information element, or an inter-RAT information element.

In some examples, selecting a shared cell during a cell reselection may be based on cells included in the MOCN PLMN identity list. For example, the UE 115-b may identify a first PLMN identity from the MOCN PLMN identity list that is equivalent to a PLMN identity registered to the UE 115-b, where the first PLMN identity is one of multiple PLMN identities associated with the shared cell. The UE 115-b may then communicate with the network entity 105-c associated with the shared cell based on the shared cell being associated with the PLMN identity being equivalent to the PLMN identity registered to the UE 115-b.

In some other examples, the UE 115-b may identify, based on the MOCN PLMN identity list, one or more cells that are each associated with PLMN identities that are not equivalent to the PLMN identity registered to the UE 115-b. The UE 115-b may then bar the one or more cells for a time duration based on the PLMN identities being not equivalent to the PLMN identity registered to the UE 115-b.

At 315, the UE 115-b may perform a cell reselection procedure to select a cell associated with the frequency based on the cell satisfying a threshold (e.g., a rank or quality threshold).

At 320, the UE 115-b may select, as part of the cell reselection procedure, a shared cell associated with the frequency based on the cell being unavailable for selection and the MOCN frequency indicator indicating that the frequency is configured with the at least one shared cell (e.g., where the cell is unavailable based on a PLMN identity associated with the cell being different from a PLMN registered to the UE 115-b).

In some examples, the UE 115-b may refrain from barring the frequency in response to a determination that the cell associated with the frequency is unavailable for selection, where the frequency is excluded from barring based on the MOCN frequency indicator indicating that the frequency is configured with the at least one shared cell. The UE 115-b may then search, as part of the cell reselection procedure, for the shared cell associated with the frequency based at on the frequency being excluded from barring.

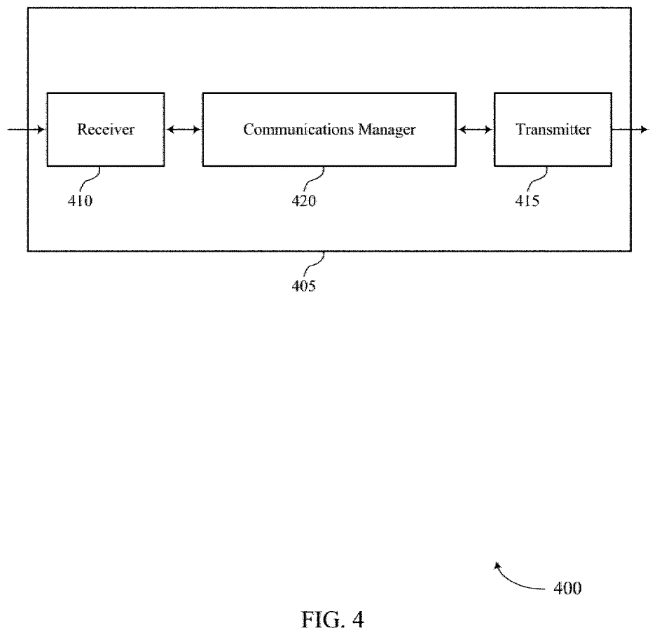

FIG. 4 illustrates a block diagram 400 of a device 405 that supports network sharing techniques for MOCN in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to network sharing techniques for MOCN). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to network sharing techniques for MOCN). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of network sharing techniques for MOCN as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for receiving a message including a multi-operator core network frequency indicator that indicates whether a frequency is configured with at least one shared cell that is associated with multiple PLMN identities. The communications manager 420 may be configured as or otherwise support a means for performing a cell reselection procedure to select a cell associated with the frequency based on the cell satisfying a threshold. The communications manager 420 may be configured as or otherwise support a means for selecting, as part of the cell reselection procedure, a shared cell associated with the frequency based on the cell being unavailable for selection and the multi-operator core network frequency indicator indicating that the frequency is configured with the at least one shared cell, where the cell is unavailable based on a PLMN identity associated with the cell.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing, enhanced cell selection, more efficient utilization of communication resources, and reduced latency.

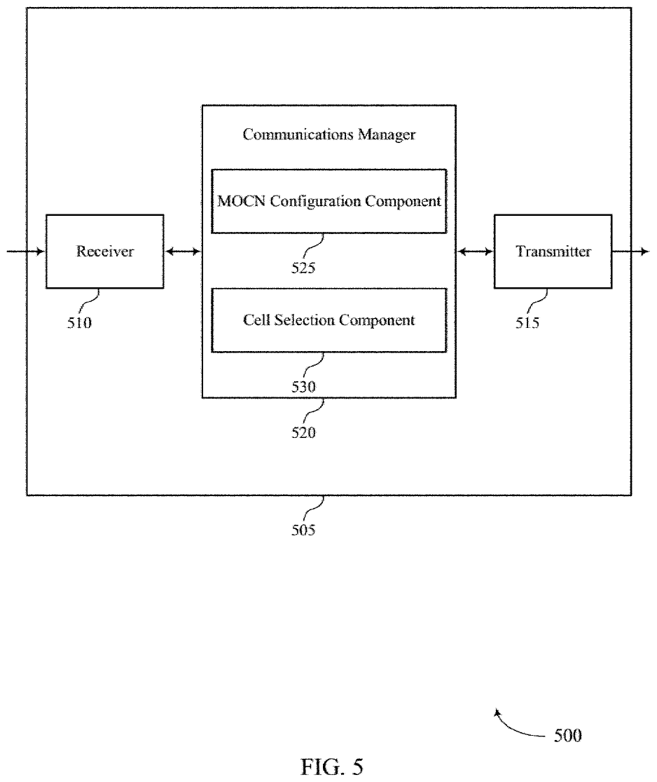

FIG. 5 illustrates a block diagram 500 of a device 505 that supports network sharing techniques for MOCN in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to network sharing techniques for MOCN). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to network sharing techniques for MOCN). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of network sharing techniques for MOCN as described herein. For example, the communications manager 520 may include a MOCN configuration component 525 a cell selection component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The MOCN configuration component 525 may be configured as or otherwise support a means for receiving a message including a multi-operator core network frequency indicator that indicates whether a frequency is configured with at least one shared cell that is associated with multiple PLMN identities. The cell selection component 530 may be configured as or otherwise support a means for performing a cell reselection procedure to select a cell associated with the frequency based on the cell satisfying a threshold. The cell selection component 530 may be configured as or otherwise support a means for selecting, as part of the cell reselection procedure, a shared cell associated with the frequency based on the cell being unavailable for selection and the multi-operator core network frequency indicator indicating that the frequency is configured with the at least one shared cell, where the cell is unavailable based on a PLMN identity associated with the cell.

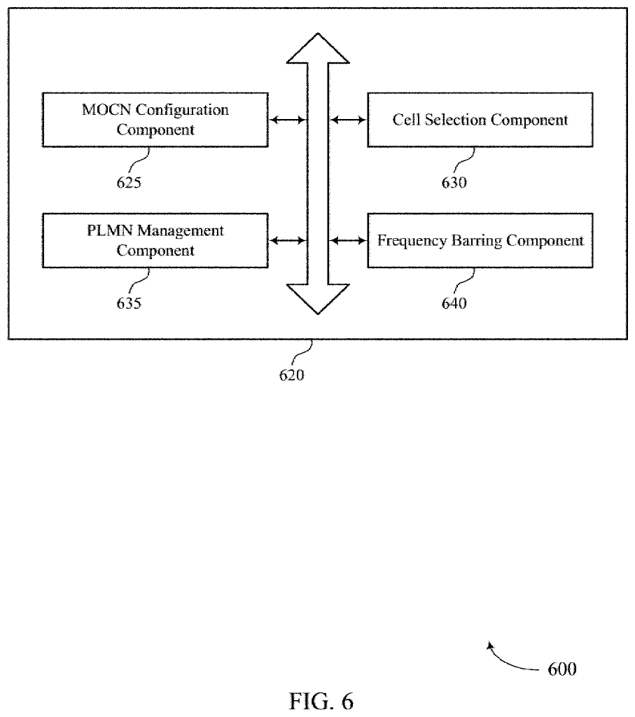

FIG. 6 illustrates a block diagram 600 of a communications manager 620 that supports network sharing techniques for MOCN in accordance with one or more aspects of the present disclosure. The communications manager 620 may be an example of aspects of a communications manager 420, a communications manager 520, or both, as described herein. The communications manager 620, or various components thereof, may be an example of means for performing various aspects of network sharing techniques for MOCN as described herein. For example, the communications manager 620 may include a MOCN configuration component 625, a cell selection component 630, an PLMN management component 635, a frequency barring component 640, or any combination thereof. Each of these components may communicate, directly or indirectly, with one another (e.g., via one or more buses).

The communications manager 620 may support wireless communication at a UE in accordance with examples as disclosed herein. The MOCN configuration component 625 may be configured as or otherwise support a means for receiving a message including a multi-operator core network frequency indicator that indicates whether a frequency is configured with at least one shared cell that is associated with multiple PLMN identities. The cell selection component 630 may be configured as or otherwise support a means for performing a cell reselection procedure to select a cell associated with the frequency based on the cell satisfying a threshold. In some examples, the cell selection component 630 may be configured as or otherwise support a means for selecting, as part of the cell reselection procedure, a shared cell associated with the frequency based on the cell being unavailable for selection and the multi-operator core network frequency indicator indicating that the frequency is configured with the at least one shared cell, where the cell is unavailable based on a PLMN identity associated with the cell.

In some examples, to support receiving the message, the PLMN management component 635 may be configured as or otherwise support a means for receiving the message including a multi-operator core network PLMN identity list that includes one or more multi-operator core network PLMN identities configured for the frequency, where selecting the shared cell is based on the multi-operator core network PLMN identity list.

In some examples, the PLMN management component 635 may be configured as or otherwise support a means for identifying a first PLMN identity from the multi-operator core network PLMN identity list that is equivalent to a PLMN identity registered to the UE, the first PLMN identity being one of multiple PLMN identities associated with the shared cell. In some examples, the cell selection component 630 may be configured as or otherwise support a means for communicating with a network entity associated with the shared cell based on the shared cell being associated with the PLMN identity that is equivalent to the PLMN identity registered to the UE.

In some examples, the PLMN management component 635 may be configured as or otherwise support a means for identifying, based on the multi-operator core network PLMN identity list, one or more cells that are each associated with PLMN identities not equivalent to a PLMN identity registered to the UE. In some examples, the frequency barring component 640 may be configured as or otherwise support a means for barring the one or more cells for a time duration based on the PLMN identities being not equivalent to the PLMN identity registered to the UE.

In some examples, the multi-operator core network PLMN identity list includes a PLMN identity information list indicating the one or more multi-operator core network PLMN identities corresponding to respective cells configured for the frequency.

In some examples, the frequency barring component 640 may be configured as or otherwise support a means for refraining from barring the frequency in response to a determination that the cell associated with the frequency is unavailable for selection, where the frequency is excluded from barring based on the multi-operator core network frequency indicator indicating that the frequency is configured with the at least one shared cell.

In some examples, the cell selection component 630 may be configured as or otherwise support a means for searching, as part of the cell reselection procedure, for the shared cell associated with the frequency based on the frequency being excluded from barring.

In some examples, to support receiving the message, the MOCN configuration component 625 may be configured as or otherwise support a means for receiving the message including the multi-operator core network frequency indicator via a broadcast message, a SIB, a unicast message, an RRC message, or any combination thereof.

In some examples, the multi-operator core network frequency indicator is included in an intra-frequency carrier information element, or an inter-frequency carrier information element, or an inter-radio access technology (RAT) information element.

In some examples, the multi-operator core network frequency indicator includes an information element including a Boolean indicator that indicates whether the frequency is configured with the at least one shared cell.

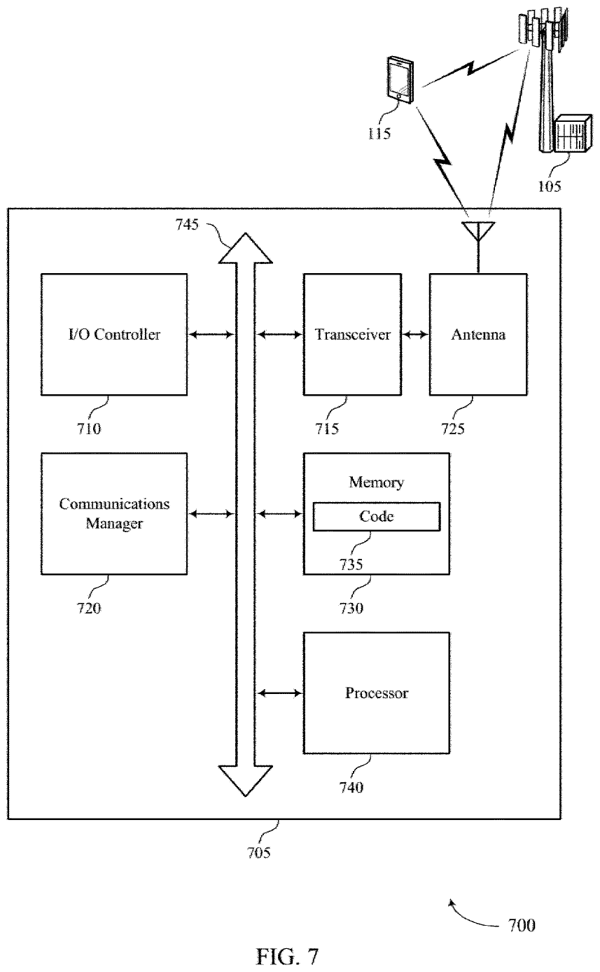

FIG. 7 illustrates a diagram of a system 700 including a device 705 that supports network sharing techniques for MOCN in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting network sharing techniques for MOCN). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving a message including a multi-operator core network frequency indicator that indicates whether a frequency is configured with at least one shared cell that is associated with multiple PLMN identities. The communications manager 720 may be configured as or otherwise support a means for performing a cell reselection procedure to select a cell associated with the frequency based on the cell satisfying a threshold. The communications manager 720 may be configured as or otherwise support a means for selecting, as part of the cell reselection procedure, a shared cell associated with the frequency based on the cell being unavailable for selection and the multi-operator core network frequency indicator indicating that the frequency is configured with the at least one shared cell, where the cell is unavailable based on a PLMN identity associated with the cell.

By including or configuring the communications manager 720 in accordance with examples as described herein, the device 705 may support techniques for improved communication reliability, reduced latency, more efficient utilization of communication resources, improved coordination between devices, increased cell selection and reselection efficiency, and enhanced coordination between multi-operator networks.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of network sharing techniques for MOCN as described herein, or the processor 740 and the memory 730 may be otherwise configured to perform or support such operations.

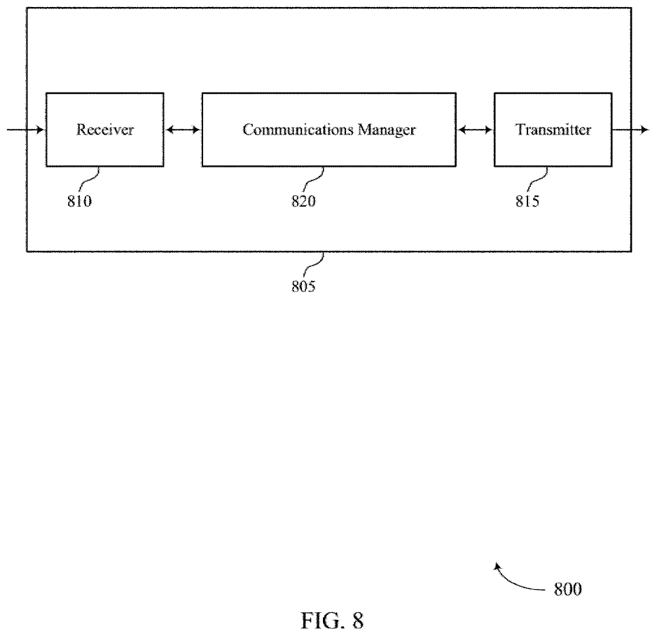

FIG. 8 illustrates a block diagram 800 of a device 805 that supports network sharing techniques for MOCN in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of network sharing techniques for MOCN as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for transmitting a message including a multi-operator core network frequency indicator that indicates whether a frequency is configured with at least one shared cell that is associated with multiple PLMN identities. The communications manager 820 may be configured as or otherwise support a means for communicating with a UE on a shared cell associated with the frequency based on the multi-operator core network frequency indicator indicating that the frequency is configured with the at least one shared cell.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, enhanced cell selection, more efficient utilization of communication resources, and reduced latency.

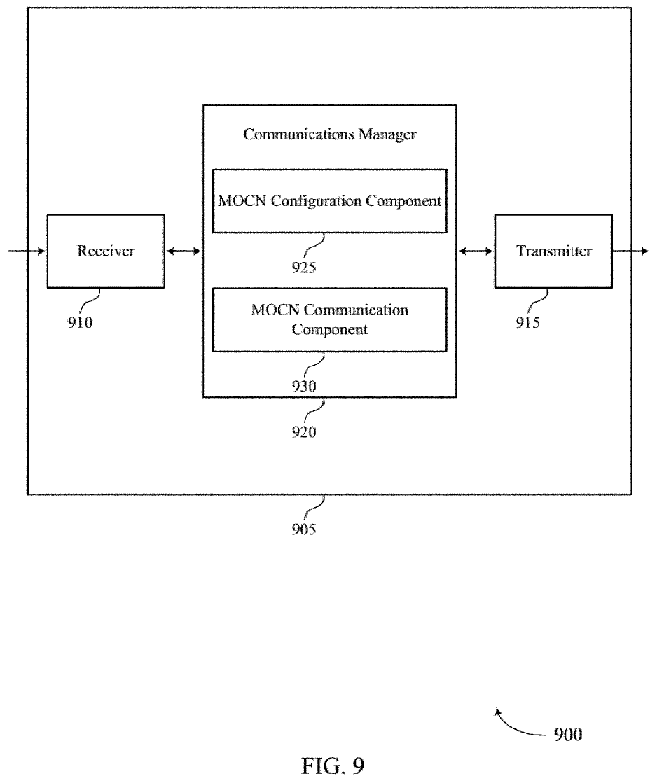

FIG. 9 illustrates a block diagram 900 of a device 905 that supports network sharing techniques for MOCN in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of network sharing techniques for MOCN as described herein. For example, the communications manager 920 may include a MOCN configuration component 925 a MOCN communication component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The MOCN configuration component 925 may be configured as or otherwise support a means for transmitting a message including a multi-operator core network frequency indicator that indicates whether a frequency is configured with at least one shared cell that is associated with multiple PLMN identities. The MOCN communication component 930 may be configured as or otherwise support a means for communicating with a UE on a shared cell associated with the frequency based on the multi-operator core network frequency indicator indicating that the frequency is configured with the at least one shared cell.

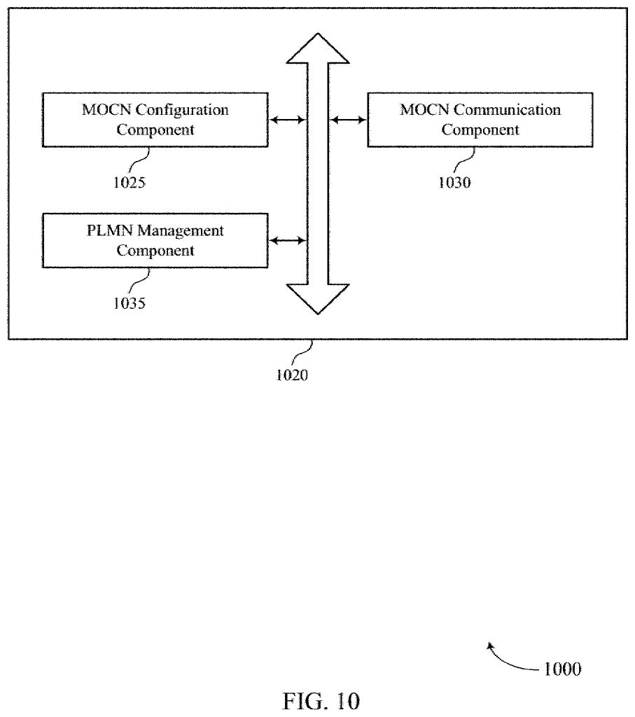

FIG. 10 illustrates a block diagram 1000 of a communications manager 1020 that supports network sharing techniques for MOCN in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of network sharing techniques for MOCN as described herein. For example, the communications manager 1020 may include a MOCN configuration component 1025, a MOCN communication component 1030, an PLMN management component 1035, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The MOCN configuration component 1025 may be configured as or otherwise support a means for transmitting a message including a multi-operator core network frequency indicator that indicates whether a frequency is configured with at least one shared cell that is associated with multiple PLMN identities. The MOCN communication component 1030 may be configured as or otherwise support a means for communicating with a UE on a shared cell associated with the frequency based on the multi-operator core network frequency indicator indicating that the frequency is configured with the at least one shared cell.

In some examples, to support transmitting the message, the PLMN management component 1035 may be configured as or otherwise support a means for transmitting the message including a multi-operator core network PLMN identity list that includes one or more multi-operator core network PLMN identities configured for the frequency, where communicating with the UE is based on the multi-operator core network PLMN identity list.

In some examples, to support communicating with the UE, the MOCN communication component 1030 may be configured as or otherwise support a means for communicating with the UE on the shared cell based on the multi-operator core network PLMN identity list including a PLMN identity that is equivalent to a PLMN identify registered to the UE.

In some examples, the multi-operator core network PLMN identity list includes a PLMN identity information list indicating the one or more multi-operator core network PLMN identities corresponding to respective cells configured for the frequency.

In some examples, to support transmitting the message, the MOCN communication component 1030 may be configured as or otherwise support a means for transmitting the message including the multi-operator core network frequency indicator via a broadcast message, a SIB, a unicast message, an RRC message, or any combination thereof.

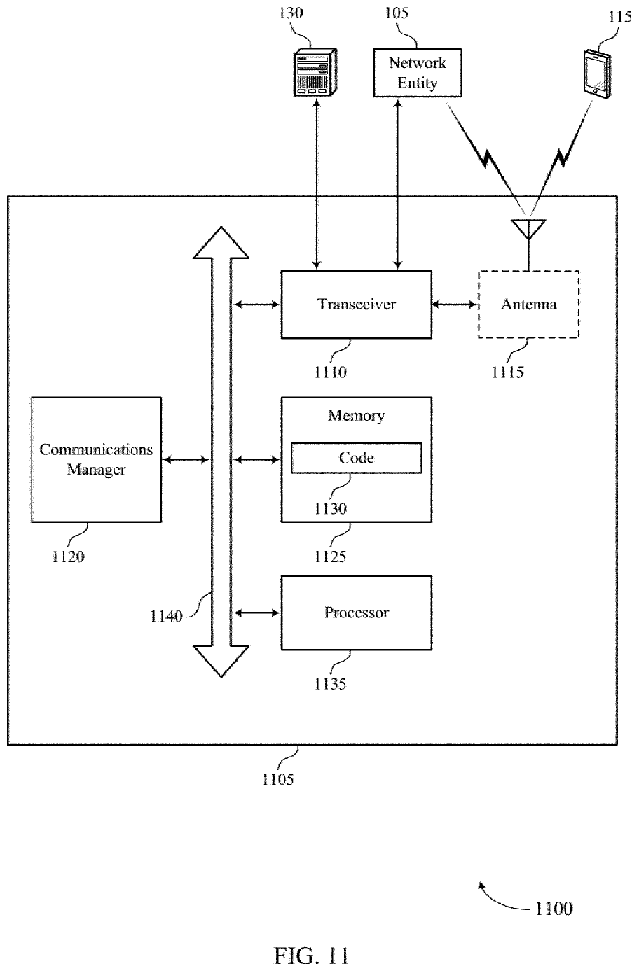

FIG. 11 illustrates a diagram of a system 1100 including a device 1105 that supports network sharing techniques for MOCN in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting network sharing techniques for MOCN). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for transmitting a message including a multi-operator core network frequency indicator that indicates whether a frequency is configured with at least one shared cell that is associated with multiple PLMN identities. The communications manager 1120 may be configured as or otherwise support a means for communicating with a UE on a shared cell associated with the frequency based on the multi-operator core network frequency indicator indicating that the frequency is configured with the at least one shared cell.

By including or configuring the communications manager 1120 in accordance with examples as described herein, the device 1105 may support techniques for improved communication reliability, reduced latency, more efficient utilization of communication resources, improved coordination between devices, increased cell selection and reselection efficiency, and enhanced coordination between multi-operator networks.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of network sharing techniques for MOCN as described herein, or the processor 1135 and the memory 1125 may be otherwise configured to perform or support such operations.

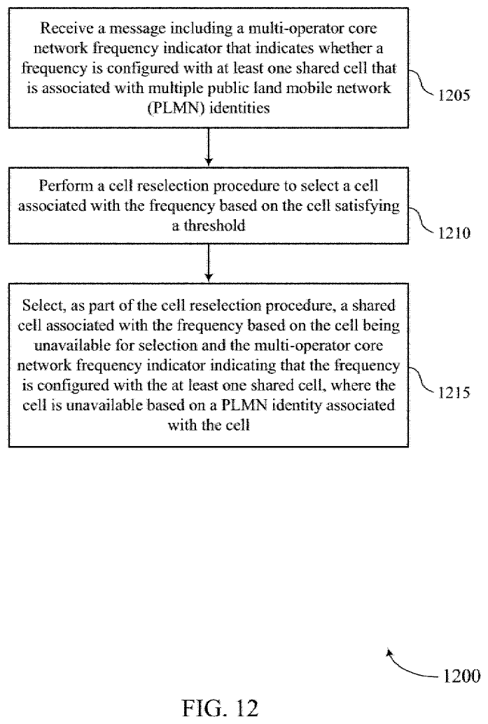

FIG. 12 illustrates a flowchart showing a method 1200 that supports network sharing techniques for MOCN in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a message including a multi-operator core network frequency indicator that indicates whether a frequency is configured with at least one shared cell that is associated with multiple PLMN identities. The operations of 1205 may be performed in accordance with examples as disclosed herein. In some examples, aspects of the operations of 1205 may be performed by a MOCN configuration component 625 as described with reference to FIG. 6.

At 1210, the method may include performing a cell reselection procedure to select a cell associated with the frequency based on the cell satisfying a threshold. The operations of 1210 may be performed in accordance with examples as disclosed herein. In some examples, aspects of the operations of 1210 may be performed by a cell selection component 630 as described with reference to FIG. 6.

At 1215, the method may include selecting, as part of the cell reselection procedure, a shared cell associated with the frequency based on the cell being unavailable for selection and the multi-operator core network frequency indicator indicating that the frequency is configured with the at least one shared cell, where the cell is unavailable based on a PLMN identity associated with the cell. The operations of 1215 may be performed in accordance with examples as disclosed herein. In some examples, aspects of the operations of 1215 may be performed by a cell selection component 630 as described with reference to FIG. 6.

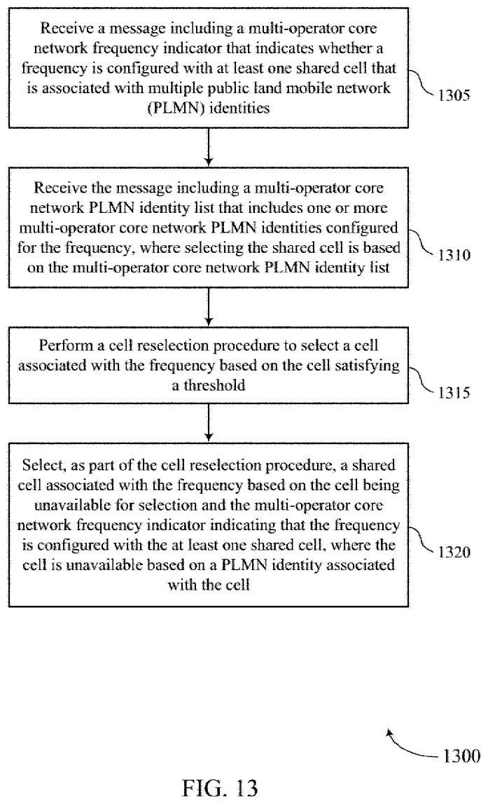

FIG. 13 illustrates a flowchart showing a method 1300 that supports network sharing techniques for MOCN in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a message including a multi-operator core network frequency indicator that indicates whether a frequency is configured with at least one shared cell that is associated with multiple PLMN identities. The operations of 1305 may be performed in accordance with examples as disclosed herein. In some examples, aspects of the operations of 1305 may be performed by a MOCN configuration component 625 as described with reference to FIG. 6.

At 1310, the method may include receiving the message including a multi-operator core network PLMN identity list that includes one or more multi-operator core network PLMN identities configured for the frequency, where selecting the shared cell is based on the multi-operator core network PLMN identity list. The operations of 1310 may be performed in accordance with examples as disclosed herein. In some examples, aspects of the operations of 1310 may be performed by an PLMN management component 635 as described with reference to FIG. 6.

At 1315, the method may include performing a cell reselection procedure to select a cell associated with the frequency based on the cell satisfying a threshold. The operations of 1315 may be performed in accordance with examples as disclosed herein. In some examples, aspects of the operations of 1315 may be performed by a cell selection component 630 as described with reference to FIG. 6.

At 1320, the method may include selecting, as part of the cell reselection procedure, a shared cell associated with the frequency based on the cell being unavailable for selection and the multi-operator core network frequency indicator indicating that the frequency is configured with the at least one shared cell, where the cell is unavailable based on a PLMN identity associated with the cell. The operations of 1320 may be performed in accordance with examples as disclosed herein. In some examples, aspects of the operations of 1320 may be performed by a cell selection component 630 as described with reference to FIG. 6.

The following provides an overview of aspects of the present disclosure:

Aspect 1: A method for wireless communication at a UE, comprising: receiving a message comprising a MOCN frequency indicator that indicates whether a frequency is configured with at least one shared cell that is associated with multiple PLMN identities; performing a cell reselection procedure to select a cell associated with the frequency based at least in part on the cell satisfying a threshold; and selecting, as part of the cell reselection procedure, a shared cell associated with the frequency based at least in part on the cell being unavailable for selection and the MOCN frequency indicator indicating that the frequency is configured with the at least one shared cell, wherein the cell is unavailable based at least in part on a PLMN identity associated with the cell.

Aspect 2: The method of aspect 1, wherein receiving the message further comprises: receiving the message comprising a MOCN PLMN identity list that includes one or more MOCN PLMN identities configured for the frequency, wherein selecting the shared cell is based at least in part on the MOCN PLMN identity list.

Aspect 3: The method of aspect 2, further comprising: identifying a first PLMN identity from the MOCN PLMN identity list that is equivalent to a PLMN identity registered to the UE, the first PLMN identity being one of the multiple PLMN identities associated with the shared cell; and communicating with a network entity associated with the shared cell based at least in part on the shared cell being associated with the PLMN identity that is equivalent to the PLMN identity registered to the UE.

Aspect 4: The method of any of aspects 2 through 3, further comprising: identifying, based at least in part on the MOCN PLMN identity list, one or more cells that are each associated with PLMN identities not equivalent to a PLMN identity registered to the UE; and barring the one or more cells for a time duration based at least in part on the PLMN identities being not equivalent to the PLMN identity registered to the UE.

Aspect 5: The method of any of aspects 2 through 4, wherein the MOCN PLMN identity list comprises a PLMN identity information list indicating the one or more MOCN PLMN identities corresponding to respective cells configured for the frequency.

Aspect 6: The method of any of aspects 1 through 5, further comprising: refraining from barring the frequency in response to a determination that the cell associated with the frequency is unavailable for selection, wherein the frequency is excluded from barring based at least in part on the MOCN frequency indicator indicating that the frequency is configured with the at least one shared cell.

Aspect 7: The method of aspect 6, further comprising: searching, as part of the cell reselection procedure, for the shared cell associated with the frequency based at least in part on the frequency being excluded from barring.

Aspect 8: The method of any of aspects 1 through 7, wherein receiving the message further comprises: receiving the message comprising the MOCN frequency indicator via a broadcast message, an SIB, a unicast message, an RRC message, or any combination thereof.

Aspect 9: The method of any of aspects 1 through 8, wherein the MOCN frequency indicator is included in an intra-frequency carrier information element, or an inter-frequency carrier information element, or an inter-RAT information element.

Aspect 10: The method of any of aspects 1 through 9, wherein the MOCN frequency indicator comprises an information element comprising a Boolean indicator that indicates whether the frequency is configured with the at least one shared cell.

Aspect 11: A method for wireless communication at a network entity, comprising: transmitting a message comprising a MOCN frequency indicator that indicates whether a frequency is configured with at least one shared cell that is associated with multiple PLMN identities; and communicating with a UE on a shared cell associated with the frequency based at least in part on the MOCN frequency indicator indicating that the frequency is configured with the at least one shared cell.

Aspect 12: The method of aspect 11, wherein transmitting the message further comprises: transmitting the message comprising a MOCN PLMN identity list that includes one or more MOCN PLMN identities configured for the frequency, wherein communicating with the UE is based at least in part on the MOCN PLMN identity list.

Aspect 13: The method of aspect 12, wherein communicating with the UE comprises: communicating with the UE on the shared cell based at least in part on the MOCN PLMN identity list including a PLMN identity that is equivalent to a PLMN identify registered to the UE.

Aspect 14: The method of any of aspects 12 through 13, wherein the MOCN PLMN identity list comprises a PLMN identity information list indicating the one or more MOCN PLMN identities corresponding to respective cells configured for the frequency.

Aspect 15: The method of any of aspects 11 through 14, wherein transmitting the message further comprises: transmitting the message comprising the MOCN frequency indicator via a broadcast message, a SIB, a unicast message, an RRC message, or any combination thereof.

Aspect 16: An apparatus for wireless communication at a UE, comprising a processor; memory coupled with the processor; and instructions stored in the memory and executable by the processor to cause the apparatus to perform a method of any of aspects 1 through 10.

Aspect 17: An apparatus for wireless communication at a UE, comprising at least one means for performing a method of any of aspects 1 through 10.

Aspect 18: A non-transitory computer-readable medium storing code for wireless communication at a UE, the code comprising instructions executable by a processor to perform a method of any of aspects 1 through 10.

Aspect 19: An apparatus for wireless communication at a network entity, comprising a processor; memory coupled with the processor; and instructions stored in the memory and executable by the processor to cause the apparatus to perform a method of any of aspects 11 through 15.

Aspect 20: An apparatus for wireless communication at a network entity, comprising at least one means for performing a method of any of aspects 11 through 15.

Aspect 21: A non-transitory computer-readable medium storing code for wireless communication at a network entity, the code comprising instructions executable by a processor to perform a method of any of aspects 11 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive a message comprising a multi-operator core network frequency indicator that indicates whether a frequency is configured with at least one shared cell that is associated with multiple public land mobile network (PLMN) identities;
perform a cell reselection procedure to select a cell associated with the frequency based at least in part on the cell satisfying a threshold; and
select, as part of the cell reselection procedure, a shared cell associated with the frequency based at least in part on the cell being unavailable for selection and the multi-operator core network frequency indicator indicating that the frequency is configured with the at least one shared cell, wherein the cell is unavailable based at least in part on a PLMN identity associated with the cell.

2. The apparatus of claim 1, wherein the instructions to receive the message are further executable by the processor to cause the apparatus to:
receive the message comprising a multi-operator core network PLMN identity list that includes one or more multi-operator core network PLMN identities configured for the frequency, wherein selecting the shared cell is based at least in part on the multi-operator core network PLMN identity list.

3. The apparatus of claim 2, wherein the instructions are further executable by the processor to cause the apparatus to:
identify a first PLMN identity from the multi-operator core network PLMN identity list that is equivalent to a PLMN identity registered to the UE, the first PLMN identity being one of multiple PLMN identities associated with the shared cell; and
communicate with a network entity associated with the shared cell based at least in part on the shared cell being associated with the PLMN identity that is equivalent to the PLMN identity registered to the UE.

4. The apparatus of claim 2, wherein the instructions are further executable by the processor to cause the apparatus to:
identifying, base at least in part on the multi-operator core network PLMN identity list, one or more cells that are each associated with PLMN identities not equivalent to a PLMN identity registered to the UE; and
bar the one or more cells for a time duration based at least in part on the PLMN identities being not equivalent to the PLMN identity registered to the UE.

5. The apparatus of claim 2, wherein the multi-operator core network PLMN identity list comprises a PLMN identity information list indicating the one or more multi-operator core network PLMN identities corresponding to respective cells configured for the frequency.

6. The apparatus of claim 1, wherein the instructions are further executable by the processor to cause the apparatus to:
refrain from barring the frequency in response to a determination that the cell associated with the frequency is unavailable for selection, wherein the frequency is excluded from barring based at least in part on the multi-operator core network frequency indicator indicating that the frequency is configured with the at least one shared cell.

7. The apparatus of claim 6, wherein the instructions are further executable by the processor to cause the apparatus to:
search, as part of the cell reselection procedure, for the shared cell associated with the frequency based at least in part on the frequency being excluded from barring.

8. The apparatus of claim 1, wherein the instructions to receive the message are further executable by the processor to cause the apparatus to:
receive the message comprising the multi-operator core network frequency indicator via a broadcast message, a system information block, a unicast message, a radio resource control message, or any combination thereof.

9. The apparatus of claim 1, wherein the multi-operator core network frequency indicator is included in an intra-frequency carrier information element, or an inter-frequency carrier information element, or an inter-radio access technology (RAT) information element.

10. The apparatus of claim 1, wherein the multi-operator core network frequency indicator comprises an information element comprising a Boolean indicator that indicates whether the frequency is configured with the at least one shared cell.

11. An apparatus for wireless communication at a network entity, comprising:
a processor;
memory coupled with the processor; and
instructions stored in the memory and executable by the processor to cause the apparatus to:
transmit a message comprising a multi-operator core network frequency indicator that indicates whether a frequency is configured with at least one shared cell that is associated with multiple public land mobile network (PLMN) identities; and
communicate with a user equipment (UE) on a shared cell associated with the frequency based at least in part on the multi-operator core network frequency indicator indicating that the frequency is configured with the at least one shared cell.

12. The apparatus of claim 11, wherein the instructions to transmit the message are further executable by the processor to cause the apparatus to:
transmit the message comprising a multi-operator core network PLMN identity list that includes one or more multi-operator core network PLMN identities configured for the frequency, wherein communicating with the UE is based at least in part on the multi-operator core network PLMN identity list.

13. The apparatus of claim 12, wherein the instructions to communicate with the UE are executable by the processor to cause the apparatus to:
communicate with the UE on the shared cell based at least in part on the multi-operator core network PLMN identity list including a PLMN identity that is equivalent to a PLMN identify registered to the UE.

14. The apparatus of claim 12, wherein the multi-operator core network PLMN identity list comprises a PLMN identity information list indicating the one or more multi-operator core network PLMN identities corresponding to respective cells configured for the frequency.

15. The apparatus of claim 11, wherein the instructions to transmit the message are further executable by the processor to cause the apparatus to:
transmit the message comprising the multi-operator core network frequency indicator via a broadcast message, a system information block, a unicast message, a radio resource control message, or any combination thereof.

16. A method for wireless communication at a user equipment (UE), comprising:
receiving a message comprising a multi-operator core network frequency indicator that indicates whether a frequency is configured with at least one shared cell that is associated with multiple public land mobile network (PLMN) identities;
performing a cell reselection procedure to select a cell associated with the frequency based at least in part on the cell satisfying a threshold; and
selecting, as part of the cell reselection procedure, a shared cell associated with the frequency based at least in part on the cell being unavailable for selection and the multi-operator core network frequency indicator indicating that the frequency is configured with the at least one shared cell, wherein the cell is unavailable based at least in part on a PLMN identity associated with the cell.

17. The method of claim 16, wherein receiving the message further comprises:
receiving the message comprising a multi-operator core network PLMN identity list that includes one or more multi-operator core network PLMN identities configured for the frequency, wherein selecting the shared cell is based at least in part on the multi-operator core network PLMN identity list.

18. The method of claim 17, further comprising:
identifying a first PLMN identity from the multi-operator core network PLMN identity list that is equivalent to a PLMN identity registered to the UE, the first PLMN identity being one of multiple PLMN identities associated with the shared cell; and
communicating with a network entity associated with the shared cell based at least in part on the shared cell being associated with the PLMN identity that is equivalent to the PLMN identity registered to the UE.

19. The method of claim 17, further comprising:
identifying, based at least in part on the multi-operator core network PLMN identity list, one or more cells that are each associated with PLMN identities not equivalent to a PLMN identity registered to the UE; and
barring the one or more cells for a time duration based at least in part on the PLMN identities being not equivalent to the PLMN identity registered to the UE.

20. The method of claim 17, wherein the multi-operator core network PLMN identity list comprises a PLMN identity information list indicating the one or more multi-operator core network PLMN identities corresponding to respective cells configured for the frequency.
